(19) United States
(12) Patent Application Publication
(10) Pub. No.: US 2006/0277094 A1
(43) Pub. Date: Dec. 7, 2006

(54) Data processing system and method for regulating an installation

(76) Inventors: Jurgen Kirsch, Leverkusen (DE); Friedhelm Steffens, Leverkusen (DE)

Correspondence Address: NORRIS MCLAUGHLIN & MARCUS, P.A., P O BOX 1018, SOMERVILLE, NJ, 08876, US

(21) Appl. No.: 11/440,333

(22) Filed: May 24, 2006

(30) Foreign Application Priority Data
Jun. 2, 2005 (DE) 102005025282.6

(51) Int. Cl. G06Q 99/00; G07G 1/00; G06F 17/30

(52) U.S. Cl. 705/10; 705/1

(57) ABSTRACT

The invention relates to a data processing system having an installation controller for an installation, where the installation controller is designed to capture process variables, an installation model for calculating simulated process variables using a portion of the captured process variables; and a user interface for outputting the captured process variables and the simulated process variables.

The present application claims priority from German Patent Application No. 1020050252826 filed Jun. 2, 2005, the disclosure of which is incorporated herein by reference.

The invention relates to a data processing system, a method for monitoring an installation and a method for regulating an installation and also to relevant computer program products.

Various simulation methods for configuring installations are known from the prior art. Such simulation methods are used to simulate the design of an installation in order to validate the design. In addition, the simulation result can be taken as a basis for altering the configuration of the installation at the design stage, in order to optimize the installation. US 2001/0021900A1 has also disclosed the use of an installation model, that is to say of “model predictive control”, for controlling an installation.

By contrast, the invention is based on the object of providing an improved data processing system, a method for monitoring an installation, a method for regulating an installation and also relevant computer program products. In particular, the invention is based on the object of providing a new use for an installation model.

The objects on which the invention is based are respectively achieved by means of the features of the independent patent claims. Preferred embodiments of the invention are specified in the dependent patent claims.

The inventive data processing system has an installation controller for an installation, the installation controller being designed to capture process variables. An installation model is used to calculate simulated process variables from a portion of the captured process variables. A user interface can be used to output the captured process variables and the simulated process variables.

This has the advantage that discrepancies between captured process variables and simulated process variables can easily be detected by the operating personnel on the installation controller. If a simulated process variable differs greatly from a captured process variable, for example, this indicates that there is a fault in the capture of the relevant process variable. By way of example, the discrepancy between the captured process variable and the simulated process variable may be being caused by a faulty sensor. If greatly divergent captured and simulated process variables are output via the user interface, this can be assessed by the operating personnel as advice to check the relevant sensor(s) or meter(s) which are used for capturing the process variables.

Preferably, the input variables used for the installation model for calculating the simulated process variables are just relatively few captured process variables, specifically captured process variables which have the highest probability of being correct, in particular. These process variables are basic operating parameters for the installation, in particular, such as the currently supplied quantity of operational substances and energy. From such basic process variables, the installation model calculates simulated process variables, which can be compared with the captured process variables.

In accordance with one embodiment of the invention, the captured process variables are stored in a database. The process variables can be requested from the database by a computer. The request for the process variables from the database can be made either on the basis of an appropriate user command or within pre-programmed intervals of time, such as every 20 minutes. The computer simulates the process variables with the installation model, using the process variables requested from the database. In order to request the captured process variables from the database, the computer is networked to the database.

In accordance with one embodiment of the invention, the captured process variables requested from the database by the computer are stored locally. A further user interface can be used to access the captured process variables in order to alter them. A subsequent simulation can establish whether the alteration in the process variables results in improvement in the manufacturing process, particularly in a reduction in cost.

In accordance with another embodiment of the invention, the computer has an optimizer for optimizing the process variables. To this end, the optimizer alters one or more of the captured or simulated process variables. When the process variables have been altered by the optimizer, a simulation is carried out. A criterion for optimization may be, in particular, the quantity of operational substances which are to be supplied, such as starting materials, solvents, catalysts, etc., the quantity of energy which is to be supplied or the manufacturing costs. Preferably, cost parameters are requested from a database in order to perform the optimization. The cost parameters may be input into the database manually. Alternatively, the cost parameters may also be read from an “Enterprise Resource Planning” (ERP) system.

In accordance with one embodiment of the invention, the computer generates a file containing the optimized processed variables obtained by means of the simulation. The file is transmitted from the computer to the installation controller via a network.

A process control system of this type can be used for a multiplicity of processes, for example for manufacturing polymers, preferably for manufacturing synthetic rubbers, such as EPDM (ethylene-propylene-diene rubber), CR (polychloroprene rubber), NBR (nitrile-butadiene rubber), HNBR (hydrogenated nitrile-butadiene rubber), SBR (styrene butadiene rubber), BR (polybutadiene rubber), EVM (ethylene vinyl acetate rubber) or else IIR (butyl rubber).

Particularly advantageously, the present invention can be used for manufacturing isocyanates, particularly TDI. To manufacture TDI, toluenediamine (TDA) is dissolved in phosgene. The solvent used is ortho dichlorobenzene (ODB), for example. The chemical reaction for manufacturing the TDI can take place in one or more subreactions, specifically in one or more reactors.

When the TDA has reacted with the phosgene, gaseous hydrochloric acid with phosgene and also solvent with TDI are obtained in addition to the TDA. The TDI is separated from the gaseous hydrochloric acid by means of distillation. The gaseous hydrochloric acid is then cooled to 15° C., for example, in order to recover the phosgene and the solvent through condensation. The phosgene and the solvent can in this way be recycled into the process.

Normally, the manufacture of TDI is regulated so that the yield is as high as possible. In this context, the yield refers to the proportion of TDA molecules which is converted into TDI molecules during the reaction. However, a drawback in this case is that a high yield requires a high proportion of solvent, which can result in relatively high costs for energy and materials. By contrast, the present invention allows the manufacture of TDI to be controlled to optimize the quantities of operational substances and energy which are to be provided and hence the manufacturing costs.

Preferred embodiments of the invention are explained in more detail below with reference to the drawings, in which:

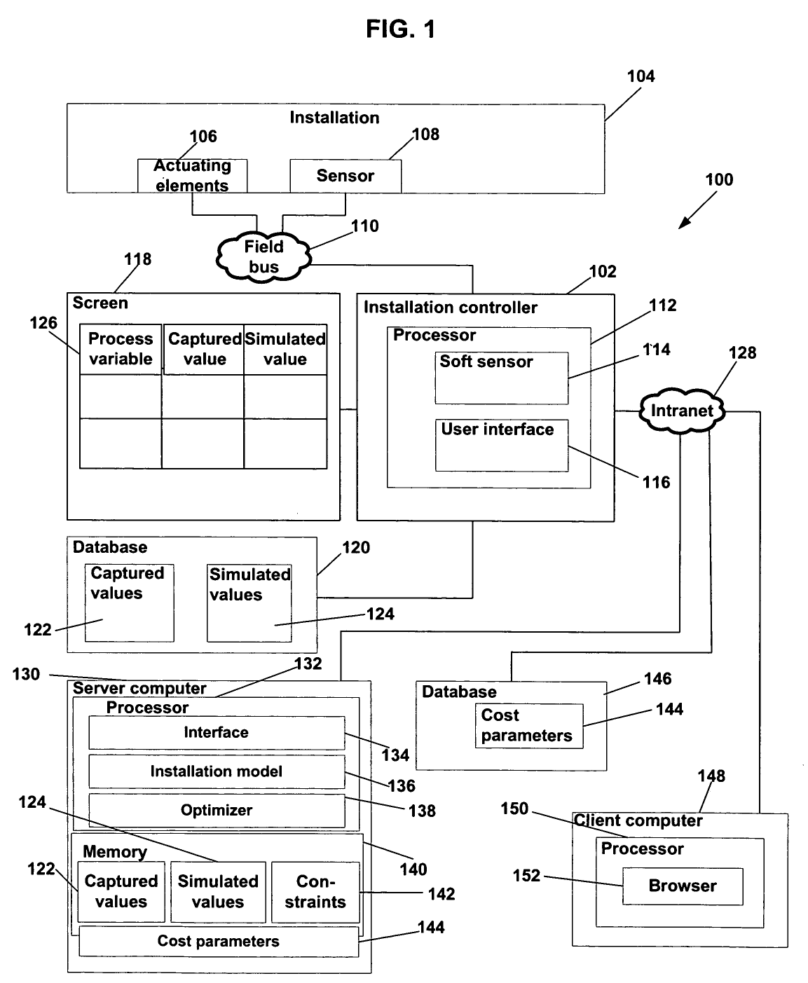

FIG. 1 shows a block diagram of a preferred embodiment of a data processing system based on the invention,

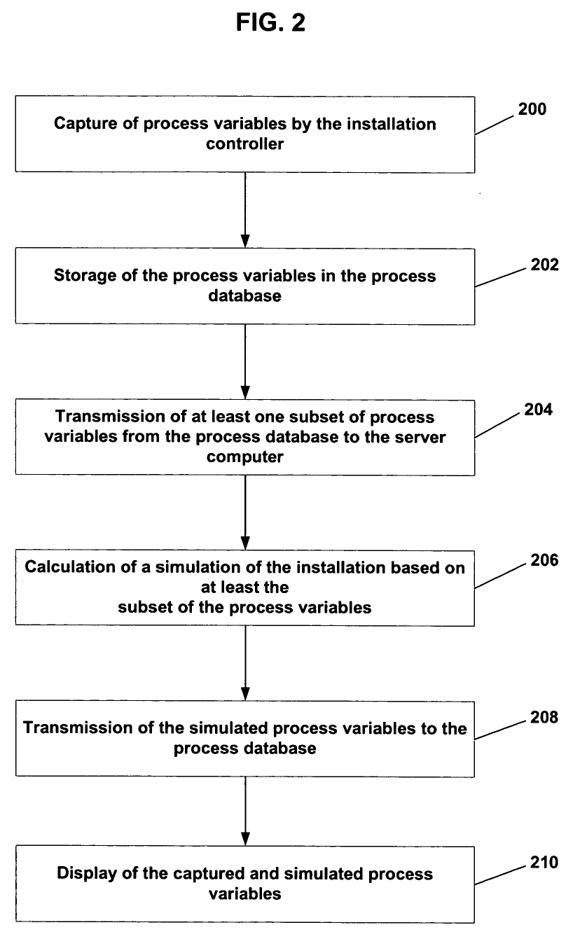

FIG. 2 shows a flowchart for a preferred embodiment of a monitoring method based on the invention,

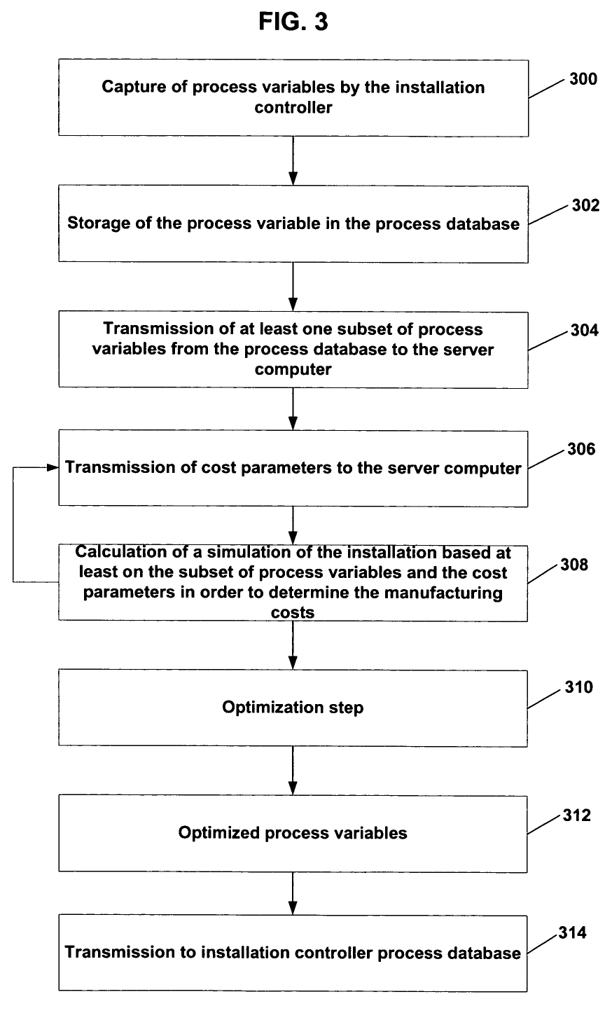

FIG. 3 shows a flowchart for a preferred embodiment of a regulating method based on the invention.

FIG. 1 shows a block diagram of a data processing system 100. The data processing 100 has an installation controller 102 for controlling and/or regulating an installation 104. The installation controller 102 is a “process control system”, for example, which can be produced by one or more programmable logic controllers (PLCs).

By way of example, the installation 104 is a chemical production plant for manufacturing a substance by supplying operational substances and energy. As an example, the installation 104 is used for manufacturing TDI from TDA, which is dissolved in phosgene. The solvent used is preferably ODB.

The installation 104 has actuating elements 106, for example in order to set the supplied quantity of operational substances and energy, and also sensors 108 for measuring process variables for the installation, such as pressures, temperatures and concentrations.

The actuating elements 106 and the sensors 108 are connected to the installation controller 102 by means of a field bus 110. The installation controller 102 has at least one processor 112 for controlling and/or regulating the installation 104. The processor 112 is used to execute a program module 114 and a program module 116. The program module 114 provides a “soft sensor”. The program module 114 is thus used to calculate a current process variable from one or more process variables measured by the sensors 108, for example.

The program module 116 provides a user interface. By way of example, the installation controller 102 has an operating console with a screen 118 and one or more input elements, such as a keyboard, a computer mouse and/or a touchscreen. The user interface provided by the program module 116 can be used by the operating personnel on the installation controller 102 to effect read or write access to process variables.

The installation controller 102 is connected to a database 120. The database 120 is used to control process variables 122 captured and calculated by the installation controller 102 and also to store process variables 124 obtained through simulation. The database 120 may be an integral part of the installation controller 102. Alternatively, the database 120 may be produced on a separate hardware component which is connected to the installation controller 102 either directly, as in the exemplary embodiment in FIG. 1, or via a network.

The user interface provided by the program module 116 is used to produce a display window with a table 126, indicating the captured and simulated values for various process variables, for example. The captured and simulated values of the process variables are read from the database 120 by the program module 116 in order to generate the table 126.

The installation controller is connected to a server computer 130 via a network 128, for example an intranet. The server computer 130 has at least one processor 132. The process 132 is used to execute the program modules 134,136 and 138. The program module 134 forms an interface on the server computer 130 for requesting the captured process variables 122 from the installation controller 102 or its database 120 via the network 128. The program module 136 is an installation model of the installation 104. The program module 136 can be used to calculate simulated process variables from a few basic process variables for the installation, such as the currently supplied quantity of operational substances and energy.

The program module 138 is an optimizer for optimizing the process variables for the installation. One result of optimization may be an increase or reduction in the quantity of solvent used, for example, in order to minimize the variable manufacturing costs as a result.

The server computer 130 has a memory 140 for storing the captured process variables 122 retrieved from the database 120 and also the simulated process variables 124 calculated by the program module 136. In addition, the memory 140 is used for storing constraints 142 for the program module 138. The constraints 142 may be constraints for operating the installation 104, for example, such as engineering related maximum or minimum limits, or quality standards which are to be observed.

In addition, the memory 140 is used to store cost parameters 144. The cost parameters 144 are the costs of the operational substances used and energy costs, for example. The cost parameters 144 can be stored and maintained locally in the memory 140 on a continual basis. Alternatively, the cost parameters are stored in a database 146 which can be accessed by the server computer 130 via the network 128. The database 146 may be part of an “ERP” system, for example an SAP R/3 system.

The data processing system 100 also has a client computer 148 with at least one processor 150 for executing a “browser program” 152. The client computer 148 can access the server computer 130 via the network 128 in order to display the captured process variables 122 stored in the memory 140 and/or the simulated process variables 124 using the browser program 152 or to input an alteration to one or more of these values.

During operation, the installation controller 102 continually captures process variables from the sensors 108 and from the soft sensor provided by the program module 114. The process variables 122 captured by the installation controller 102 are stored in the database 120. The server computer 130 uses its program module 134 to access the database 120 via the network 128 in order to read the captured process variables 122. This can be done either on the basis of a manual input request from a user or within pre-programmed intervals of time, such as every 20 minutes. In this case, it is sufficient if just a portion of the captured process variables 122 is transmitted to the server computer 130. Of particular interest are those captured process variables 122 which relate to basic operating parameters for the installation 104, such as the quantity of operational substances and energy supplied per unit time.

The captured process variables 122 or a portion of these captured process variables 122 is/are stored in the memory 140 of the server computer 130. The program module 136 is then started in order to calculate the simulated process variables 124 using the installation model. The simulated values 124 are stored in the memory 140. The simulated values 124 are preferably all values calculated by means of the simulation using the installation model.

In one instance of application, the simulated process variables 124 are transmitted from the server computer 130 via the network 128 to the installation controller 102, which stores the simulated process variables 124 in the database 120. The program module 116 then generates the table 126 by reading the captured process variables 122 and the simulated process variables 124 from the database 120. This allows the operating personnel on the installation controller 102 to detect at a glance, and intuitively, whether there are fundamental discrepancies between a captured value and a simulated value. If a captured value differs from a simulated value significantly, this indicates that one of the sensors 108 is faulty, for example. The sensor(s) 108 in question can then be checked to correct the fault.

In another instance of application, following calculation of the simulated process variables 124 and storage thereof in the memory 140, the program module 138 is started in order to optimize the process variables. To this end, the program module 138 accesses the constraints 142 and the cost parameters 144. The program module 138 varies the simulated process variables 124. The varied process variables are input into the program module 136 in order to use the installation model to calculate new simulated values 124. In particular, the simulated values 124 include the manufacturing costs, for example the manufacturing costs per ton.

Once the program module 138 has reached a termination condition, such as a prescribed maximum number of optimization steps, the simulated process variables 124 which are the result of the optimization are transmitted to the installation controller 102 as a file. The optimized process variables can be shown on the screen 118 by the program module 116, so that the operating personnel on the installation controller 102 can accept the optimized process variables. By way of example, changing to the optimized process variables requires the operating personnel to input confirmation, so that the installation controller 102 is subsequently operated on the basis of the optimized process variables.

In addition, it is also possible to transmit the captured process variables 122 and/or the simulated process variables 124, which are stored in the memory 140, to the client computer 148 via the network 128 in order to display them using the browser program 152. The user of the client computer 148 can alter one or more of the captured or simulated values in order to start the program module 136 for performing a simulation on this basis. If the result of the simulation is advantageous, the user can input a command into the browser program 152, so that the relevant optimized process variables are transmitted from the server computer 130 to the installation controller 102.

FIG. 2 shows a corresponding flowchart. In step 200, the installation controller captures process variables from ongoing operation of the installation. These captured process variables are stored in a process database (cf. database 120 in FIG. 1) in step 202. In step 204, at least one subset of the captured process variables is transmitted to a server computer from the process database. On this basis, the server computer calculates a simulation for the installation (step 206). The simulated process variables obtained through the simulation are transmitted to the process database by the server computer in step 208.

In step 210, both the captured and the simulated process variables are output, that is to say are displayed on a screen, for example. In the event of discrepancies between the captured and simulated process variables, the operating personnel can intervene in order to identify and correct a possible fault.

FIG. 3 shows a flowchart for optimization of the manufacturing costs.

Steps 300, 302 and 304 correspond to steps 200, 202 and 204 in FIG. 2. In step 306, cost parameters are additionally transmitted to the server computer. On the basis of the important process variables and the cost parameters, a simulation is performed using the installation model (step 308). Besides the simulated process variables, such as the quantities of operational means and energy which are to be provided, the manufacturing costs are a result of the simulation. In step 310, the simulated process variables and the constraints are taken as a basis for carrying out an optimization step in which the simulated process variables are varied.

Next, in step 308, a simulation is performed again on the basis of the important varied process variables, particularly in order to calculate the new manufacturing costs. After that, one or more further optimization steps 310 and subsequent simulations 308 can be performed, until a termination condition has been reached. This may be a maximum number of iterations or another termination criterion, for example.

In step 312, the optimized process variables are output. The optimized process variables are transmitted to the installation controller or its process database in step 314. The optimized process variables can automatically replace the previous process variables. Preferably, however, this requires express confirmation by the operating personnel on the installation controller.

What is claimed is:

1. Data processing system having
an installation controller for an installation, the installation controller being designed to capture process variables which have been measured or derived through calculation;
an installation model for calculating simulated process variables using a portion of the captured process variables; and
at least one user interface for outputting the captured process variables and the simulated process variables.

2. Data processing system according to claim 1, having a first database for storing the captured process variables and a computer for calculating the simulated process variables using the installation model, where the computer is designed to request the portion of the captured process variables from the first database.

3. Data processing system according to claim 2, where the computer is connected to the installation controller via a network.

4. Data processing system according to claim 1, having at least one further user interface for inputting at least one altered process variable for calculating the simulated process variables.

5. Data processing system according to claim 1, having at least one further database for storing cost parameters for use in the installation model.

6. Data processing system according to claim 1, having an optimizer for optimizing the process variables, the process variables including the quantity of operational substances which are to be provided or of energy or the manufacturing costs, using the installation model.

7. Data processing system according to claim 1, having means for transmitting optimized process variables to the installation controller.

8. Method for monitoring an installation, having the following steps:
process variables for the installation which have been measured or derived through calculation are captured;
a portion of the process variables is used to calculate simulated process variables using an installation model; and
the captured process variables and the simulated process variables are output.

9. Method for regulating an installation, having the following steps:
process variables for the installation which have been measured or derived through calculation are captured;
at least one portion of the captured process variables is used to calculate the quantity of operational substances which are to be supplied or energy or the manufacturing costs; and
an optimization step for the process variables is performed to reduce the quantity of operational substances which are to be supplied or energy or the manufacturing costs.

10. Method according to claim 9, where the installation is designed for manufacturing TDI from TDA using a reactant and solvent, where the reactant is recycled through condensation by supplying energy, and the solvent is recycled through distillation by supplying energy, the calculation of the manufacturing costs including the energy costs and the costs of the TDA.

11. Computer program product, particularly a digital storage medium, for carrying out a method according to claim 8.

12. Computer program product, particularly a digital storage medium, for carrying out a method according to claim 9.
